(19) United States
(12) Patent Application Publication
(10) Pub. No.: US 2026/0369113 A1
(43) Pub. Date: Nov. 19, 2026

(54) WIRELESS LOCK MECHANISMS HAVING CENTRALIZED AND DE-CENTRALIZED LOCKDOWN FUNCTIONALITY

(71) Applicant: EYES OPEN Corp., Manassas, VA (US)

(72) Inventor: Anatoli Stobbe, Barsinghausen (DE)

(21) Appl. No.: 19/682,316

(22) Filed: May 19, 2026

Related U.S. Application Data
(60) Provisional application No. 63/808,592, filed on May 19, 2025.

(51) Int. Cl. G07C 9/00

(52) U.S. Cl. CPC G07C 9/00571; G07C 9/00309; G07C 2009/00642; G07C 2009/00769; G07C 2209/62

(57) ABSTRACT

A wireless access control system provides centralized and local lockdown functionality for multiple enclosed areas secured by doors with wireless lock mechanisms. Each lock includes an external credential reader for standard access, an internal credential reader for local lockdown control, and a wireless module for receiving commands from a central controller. A visual indicator with a rotatable, backlit display provides a 1800 viewing angle to show locked or unlocked status. The system allows authorized personnel to override lockdowns using master credentials. Door position sensors and tamper-detect battery covers may be included. The system supports multiple operating modes for real-time, local, or card-based control. The architecture enables secure ingress and egress management and rapid lockdown response from central or local sources.

### RELATED APPLICATIONS

This application claims the benefit of U.S. Provisional Patent Application No. 63/808,592 filed on May 19, 2025, the entire contents of which are incorporated herein by reference.

### FIELD OF THE INVENTION

The present invention relates to electronic access control systems and, more specifically, to a wireless security control system with centralized and decentralized lockdown functionality suitable for use in educational, governmental, and commercial buildings.

### BACKGROUND OF THE INVENTION

Access control systems are widely used for managing entry into secured areas. However, existing systems often lack integrated lockdown features or the ability for authorized persons to locally override or trigger lockdowns from within the secured area. There remains a need for an enhanced wireless lock system capable of both remote and local lockdown control, with clear visual and acoustic indicators and secure override or deactivation capabilities.

### SUMMARY OF THE INVENTION

The present invention provides a wireless security control system for managing access and lockdown functionality across a plurality of enclosed areas, such as rooms within a school, office, or government building. Each enclosed area is secured by a door equipped with a wireless lock mechanism that integrates multiple components to support both normal access control and enhanced emergency lockdown capability.

Each wireless lock mechanism includes an external credential reader for standard entry from outside the enclosed area and an internal credential reader for occupants to locally activate or deactivate a lockdown condition. The lock mechanisms are capable of receiving centralized lockdown commands from a remote central controller via a wireless communication network, enabling rapid system-wide response to threats or emergencies.

The lock mechanism includes a visual status indicator, such as a rotatable transparent display plate with backlit LED indicators, capable of showing a "LOCKED" or "UNLOCKED" condition and viewable across a 180° field of vision. An auditory indicator may also be included to signal state transitions or access denials. Lockdown override capability is provided through the external credential reader, permitting designated security personnel to bypass a lockdown condition using a master credential.

The lock mechanism may include a door position sensor to detect whether the door is open or closed, and a tamper-detection battery cover to alert the system in the event of unauthorized access to the lockset components. The lock mechanism is powered by onboard batteries and includes a clutch assembly that controls mechanical engagement with the latch based on credential verification and system state.

The system architecture supports multiple operational modes, including real-time communication with a central controller (DOC mode), decentralized local data processing (DLD mode), and credential-based access logic stored on the transponder cards themselves (DCN mode). These flexible modes of operation allow the system to function reliably even in environments with intermittent connectivity or strict security requirements.

By integrating centralized control, local override capabilities, real-time status indicators, and flexible access logic, the present invention provides a robust and adaptable solution for modern access control systems, enhancing both day-to-day usability and emergency response effectiveness.

### BRIEF DESCRIPTION OF THE DRAWINGS

FIG. 1 is a side view of a wireless lockset of the present invention with the inside portion of the lockset shown on the right and the outside portion of the lockset shown on the left.

FIG. 2 is a front view of the outside portion of the lockset shown in FIG. 1.

FIG. 3 is a perspective view of the inside portion of the lockset with a visual indicator showing a locked condition.

FIG. 4 is a perspective view of the inside portion of the lockset with the visual indicator showing an unlocked condition.

FIG. 5 is a perspective view of a door equipped with a lockset of the present invention, with the inside portion of the lockset removed from the door to illustrate the internal assembly of the lockset.

FIG. 6 is an exploded perspective view of the inside portion of the lockset showing the escutchion cover, the visual locked/unlocked indicator, and the internal assembly of the lockset.

FIG. 7 is a front view of the escutcheon cover shown in FIG. 6, together with the inside credential reader and the visual locked/unlocked indicator.

FIG. 8 is a perspective view of the read head of the inside credential reader.

FIG. 9 is an exploded perspective view of the visual indicator and the mechanism for rotating the visual indicator between locked and unlocked indications.

FIG. 10 is a rear view of the mechanism for rotating the visual indicator.

FIG. 11 is a rear view of the visual indicator, which includes a transparent indicator plate and a motor for rotating the indicator plate.

FIG. 12 is an exploded perspective view of the outside portion of the lockset showing the outside credential reader and the internal clutch assembly for opening the door.

FIG. 13 is a front view of the internal clutch assembly for opening the door.

FIG. 14 is an exploded perspective view of the internal clutch assembly for opening the door.

FIG. 15 is a schematic block diagram showing the system communication between the locksets, central controller and transponders.

FIG. 16 is a flowchart showing the security control system providing central and de-central control of the lockdown feature.

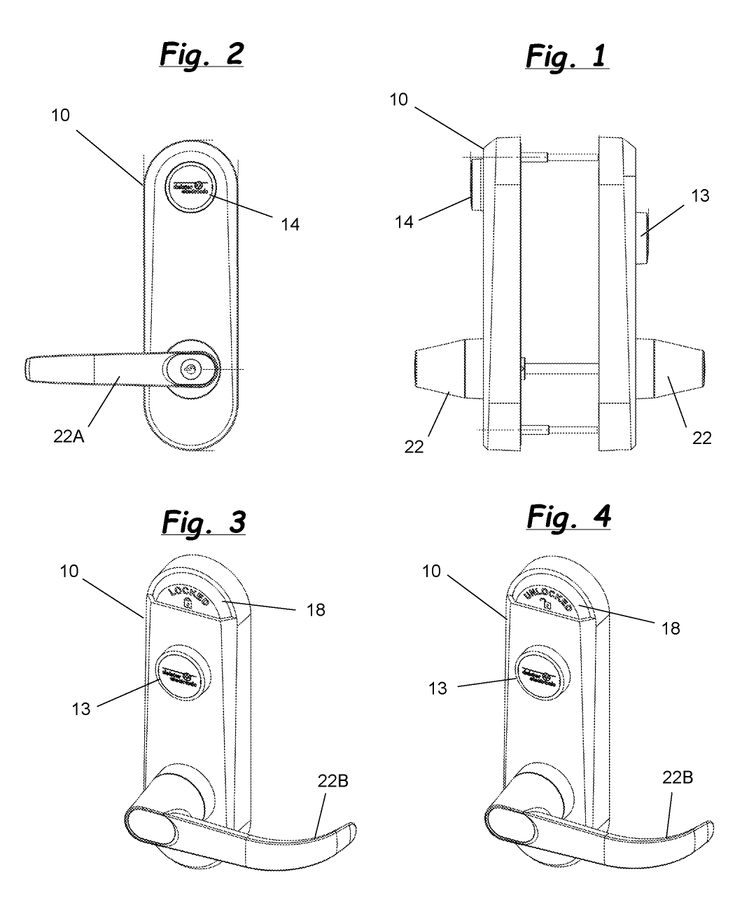

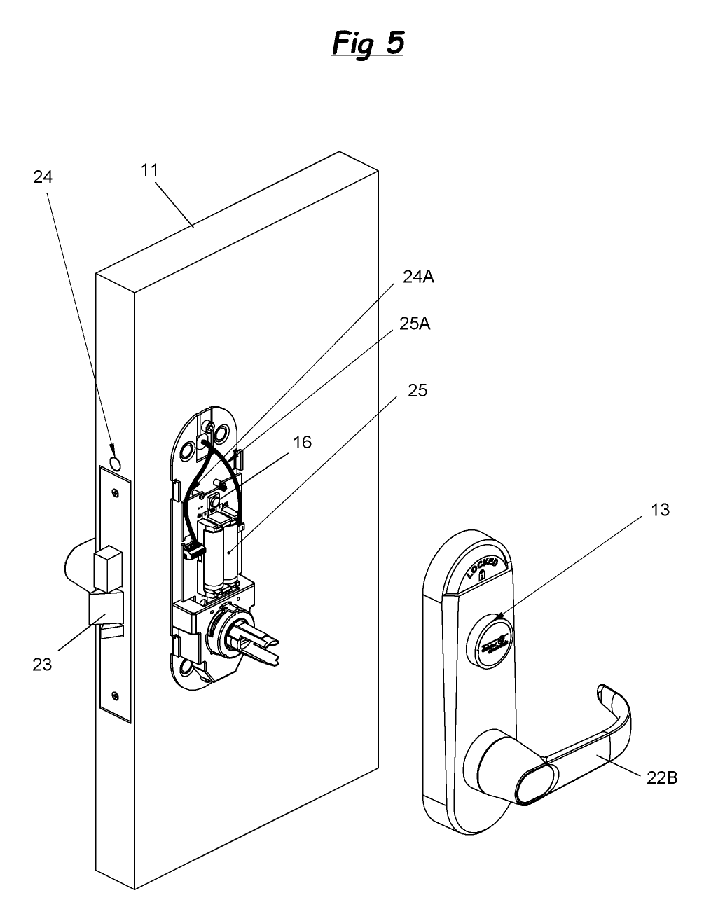

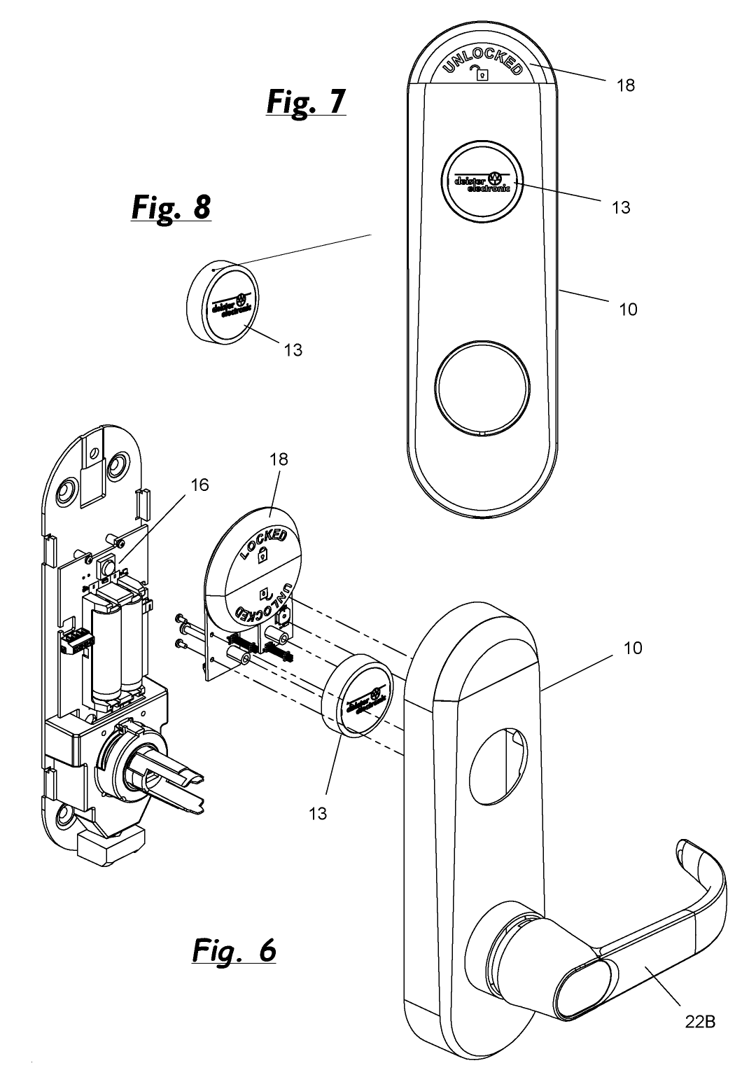

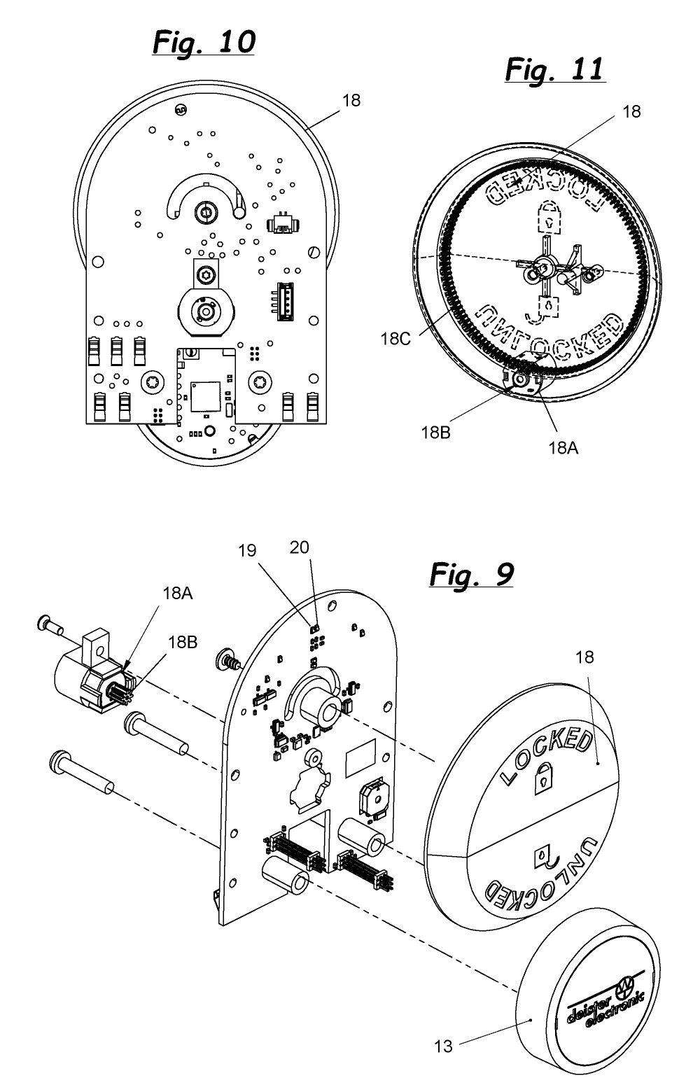

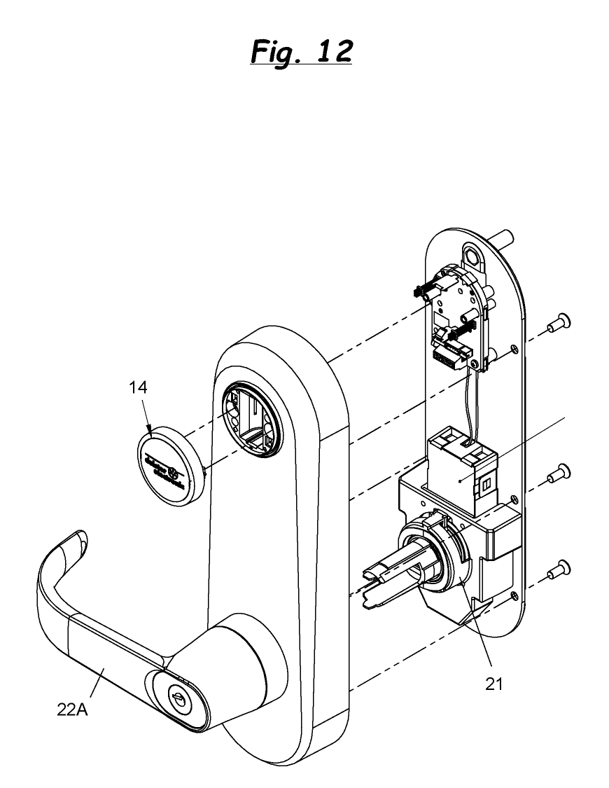

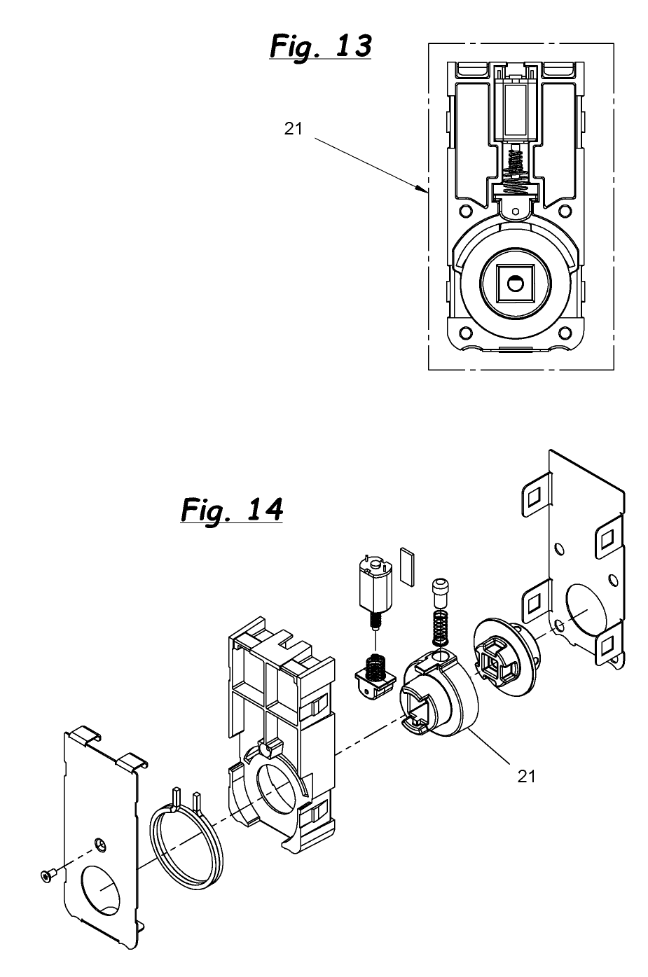

### DETAILED DESCRIPTION OF THE INVENTION

The present invention provides a wireless electronic access control system with centralized and decentralized lockdown capabilities, particularly suited for use in institutional, commercial, and governmental buildings. The system comprises a plurality of electronically controlled locksets 10 mounted on doors 11 to secure enclosed areas, a central controller 12 for system-wide command dissemination, and a set of internal credential readers 13 and external credential readers 14 enabling secure, bidirectional user interaction. Each lockset 10 is equipped with visual indicators 15 and optionally auditory indicators to display operational status.

### System Overview

Each secured door 11 in the system is outfitted with a wireless lock mechanism 10 that includes the following main components:
1. External Credential Reader
Mounted on the outer surface of the door, the external credential reader 14 is used for standard access control. It is configured to authenticate user credentials using contactless technologies such as RFID (e.g., MIFARE®, HID®, Legic®, cipherCard®), NFC, or Bluetooth Low Energy (BLE). Upon presentation of a valid credential, the lockset 10 transitions to an unlocked state, allowing the user to open the door 11. If the door 11 is in a lockdown condition, the external credential reader 14 will deny access unless a master or override credential is presented.
2. Internal Credential Reader
Located on the interior side of the door, the internal credential reader 13 permits authorized occupants of the secured space to activate or deactivate a lockdown mode by presenting a valid credential. In one embodiment, the same credential can be used to toggle the lockdown status. The internal reader 13 also acts as a local override mechanism in emergencies, independent of the central controller 12.
3. Wireless Communication Module
Each lockset 10 contains a wireless transceiver 16 as a communication module configured to receive and transmit data via secure communication protocols. In one embodiment, communication occurs over a proprietary communications platform, which enables encrypted wireless communication between the locksets 10 and the central controller 12 or networked management software. The communication module 16 also enables the lockset to receive centralized lockdown commands and transmit door status data, such as position or access attempts.

### 4. Lockdown Control and Override Functionality

Lockdown mode may be triggered in one of two ways:
Central Command: A central controller 12 can broadcast a lockdown signal to all or selected locksets 10 in the building. Upon receiving this command, the lockset 10 engages the locking mechanism 17, rendering the door 11 inoperable from both sides except by master credentials.
Local Activation: An authorized individual inside the room can activate lockdown mode by presenting a credential to the internal reader 13. The system will verify the credential and, if authorized, transition the lockset 10 into lockdown.
Lockdown override is allowed through the presentation of a master credential to the external reader 14. This override function is restricted to designated security personnel and is verified either by the local lockset 10 or via the central controller 12.

### 5. Visual Status Indicator

The interior side of the lockset 10 includes a motor-driven transparent rotating indicator plate 18 that displays the current status of the lock (e.g., "LOCKED" or "UNLOCKED"). This plate 18 is backlit by LEDs 19, 20 that are visible from a wide viewing angle (up to 180°) to allow occupants to immediately ascertain the security status of the door. In one embodiment a flashing red LED 19 indicates the lockset 10 is in lockdown mode, and a green LED 20 indicates normal operation. The rotation of the indicator plate 18 is controlled via the internal credential reader 13, which toggles the indicator plate 18 upon successful credential presentation. A motor 18A with a drive gear 18B mated with a driven gear 18C on the indicator plate 18 provides a drive mechanism for rotating the indicator plate 18 between its two positions for indicating “LOCKED” and “UNLOCKED” status.

### 6. Auditory Feedback

In addition to the visual indicator 18, the lockset 10 may emit auditory signals during state transitions. For example, a short tone may indicate successful credential authentication, while a sequence of beeps may indicate lockdown activation, denial of access, or error conditions.

### 7. Internal Clutch Mechanism

The locking mechanism 17 includes an internal clutch assembly 21 which is controlled by the credential readers 13, 14. Upon validation of an external credential, the clutch assembly 21 engages to allow the handle 22 to actuate the latch mechanism 23 and open the door. If the credential is invalid or if the system is in lockdown mode, the clutch assembly 21 remains disengaged, preventing the handle 22 from operating the latch mechanism 23. The handle 22 can be either the outside handle 22A or the inside handle 22B, either of which can be selectively engaged with the latch mechanism 23 via the clutch assembly 21.

### 8. Door Position Sensor

A magnetic or optical sensor 24 is associated with each lockset 10 to detect whether the door 11 is open or closed. The sensor 24 is a door presence sensor connected to the electronics in the lockset 10 by an electrical cable 24A. This status of the sensor 24 is communicated to the central controller 12 and can be used to issue alerts or drive conditional logic, such as auto-locking when the door 11 is closed after access.

### 9. Power Supply and Tamper Detection

The system is powered by high-capacity lithium AA batteries 25 housed within the lockset. The battery compartment is protected by a tamper-detect feature that sends an alert to the central controller 12 if the battery cover is removed or accessed without authorization. The batteries 25 are connected to the other components using battery cables 25A or other suitable conductors.

### 10. Supported Operating Modes

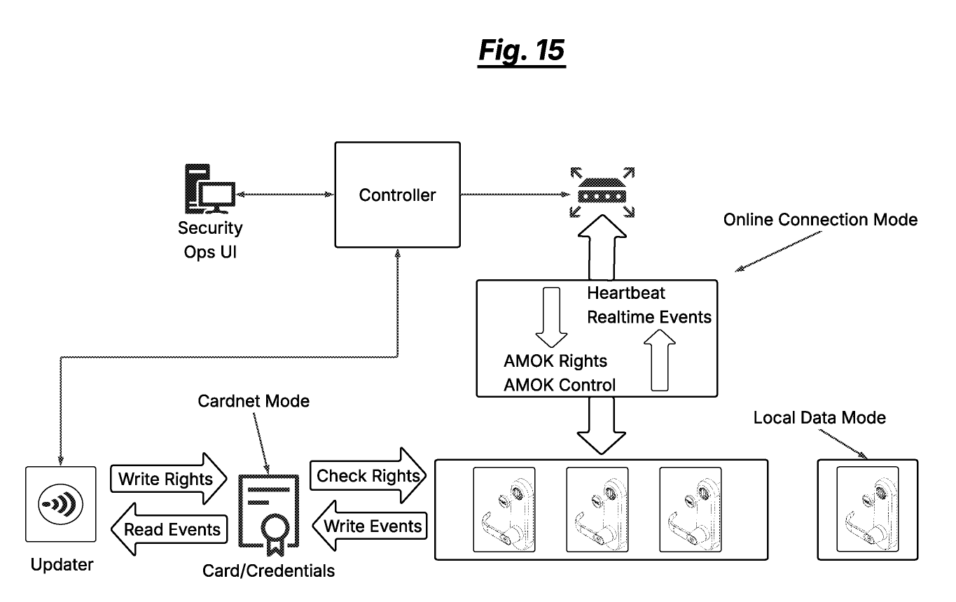

As illustrated in FIG. 15, the system is compatible with several operating modes for communication and control, including:
(1) Online Connection: Real-time communication with the central controller;
(2) Local Data: Decentralized control with access rights stored locally on the lockset; and
(3) Cardnet: Credential data stored on the access cards themselves, allowing offline verification.

### System Flow and Interactions

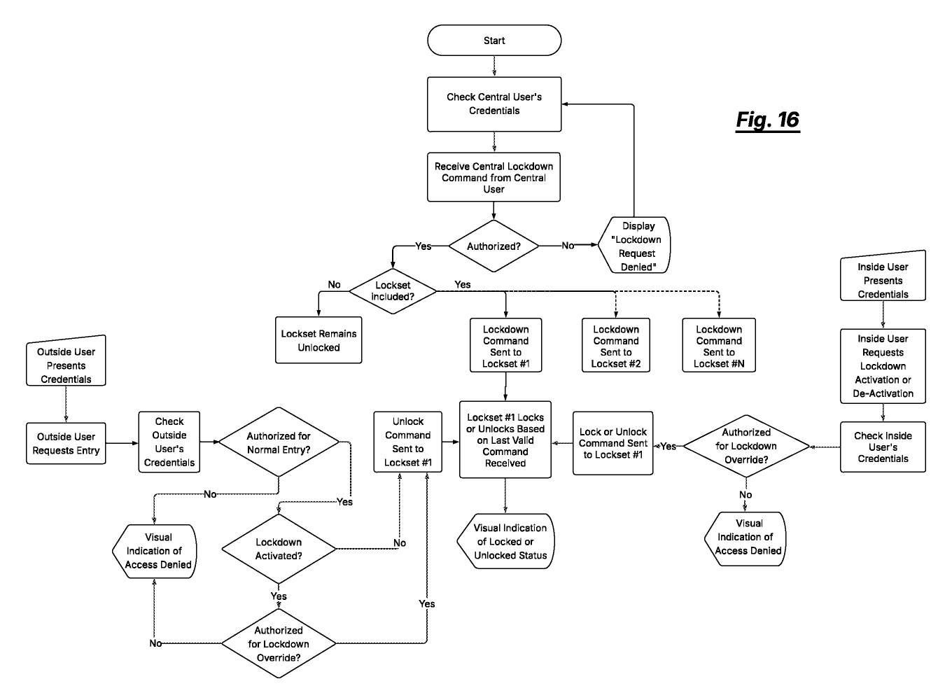

Referring to the flowchart in FIG. 16, the access control process begins with either an internal or external user presenting a credential. Depending on whether the system is in normal or lockdown mode, and based on the credential's authorization level, the lockset will perform one of the following actions:

Grant entry (by unlocking the door),

Activate lockdown (if authorized and requested internally),

Override lockdown (if master credential is presented externally), or

Deny access (with visual and optional auditory notification).

During centralized lockdown activation, the central controller 12 issues simultaneous commands to multiple locksets. Each lockset independently verifies inclusion in the lockdown group and transitions into the lockdown state if applicable. The internal reader 13 retains the ability to deactivate lockdown only if permitted by policy.

More specifically, FIG. 16 illustrates an exemplary process flow for centrally controlling one or more remotely controllable locksets, including one or more interior locksets, in response to credentials presented by a user. The illustrated process may be implemented by a central controller, an access-control panel, a distributed controller, a networked control system, one or more processors executing instructions stored in memory, or any suitable combination of hardware and software. Although the embodiment is described with reference to locksets associated with doors, the process may be applied to any controllable locking device, access point, compartment, cabinet, enclosure, gate, or other secured structure.

The process begins at a start state. A central user credential is checked by the system. The central user credential may be received from a central credential reader, a user interface, a keypad, a card reader, a biometric reader, a mobile device, a wireless token, a networked access-control system, or another authentication device. The credential may correspond to a user seeking access to one or more secured areas controlled by one or more locksets.

After receiving or checking the central user credential, the system receives or identifies a central lock/unlock command from the credentialed user. The command may be entered locally at a central control station, transmitted from a mobile device, received from a remote access-control server, generated by a building-management system, or otherwise provided to the central controller. The command may request locking, unlocking, or status control of one or more locksets.

The system then determines whether the credentialed user is authorized to issue the requested command. Authorization may be determined by comparing the credential and command to stored permissions, access schedules, user roles, security levels, group assignments, room assignments, lockset assignments, or other authorization criteria. If the user is not authorized, the system provides a visual indication of unauthorized access denial. The indication may be displayed at a central control panel, a user interface, a mobile device, an access terminal, or any other suitable output device. In the unauthorized case, the requested command is not executed unless an override condition applies.

If the user is authorized, the system determines whether the command involves multiple locksets. When the lockset is not included in the requested command or control group, the system may maintain the lockset in its current locked or unlocked state. In the illustrated embodiment, if a particular lockset is not included, the lockset remains unlocked. In other embodiments, the lockset may remain in whichever state existed before receipt of the command, or may default to a predetermined state based on system configuration.

When the command includes one or more locksets, the central controller generates or transmits one or more lock/unlock commands corresponding to the selected locksets. As illustrated, the command may be provided to a first lockset, a second lockset, and up to an Nth lockset. The plurality of locksets may be connected to the central controller by wired communication, wireless communication, a local network, a building-control network, a security bus, a mesh network, or any other suitable communication architecture. The locksets may be controlled sequentially, substantially simultaneously, or according to a predetermined priority or grouping.

For each selected lockset, the system may generate a lock command or an unlock command. A lock command causes the associated lockset to transition to a locked state, and an unlock command causes the associated lockset to transition to an unlocked state. In some embodiments, the command may include additional information, such as a time duration for unlocking, a lock schedule, an access level, a command source identifier, or an audit-log entry.

The flowchart further illustrates a process by which an outside user may request entry at an outside access point. The outside user presents credentials at an outside credential reader or other outside credential input device. The outside user then requests entry. The system checks the outside credentials and determines whether the outside user is authorized for normal entry. If the outside user is not authorized for normal entry, the system provides a visual indication of access denial. This visual indication may be generated at the outside reader, a door interface, a central control panel, a mobile device, or a remote monitoring station.

If the outside user is authorized for normal entry, the process proceeds to evaluate lock-down conditions. The system determines whether a lock-down condition is active. A lock-down condition may correspond to an emergency mode, security event, administrative command, time-based lockout, manual lock-down request, threat condition, restricted-access period, or any other condition under which normal access is suspended or limited. The lock-down condition may be established by the central controller or by another supervisory system.

If no lock-down condition is active, the system issues an unlock command to the first lockset. In response to the unlock command, the first lockset unlocks, allowing the outside user to pass through the associated access point. The system may then provide a visual indication that the lockset is unlocked or that access has been granted. The visual indication may include a light, display message, audible tone, mobile notification, graphical interface update, or other user-perceptible or electronically logged confirmation.

If a lock-down condition is active, the system determines whether the outside user is authorized to override the lock-down condition. The user’s override authority may be determined based on credential type, role, security level, emergency responder status, administrator status, time of day, location, or other permission data. If the outside user is not authorized to override the lock-down condition, the system provides a visual indication of access denial. The first lockset remains locked or otherwise secured.

If the outside user is authorized to override the lock-down condition, the system issues an unlock command to the first lockset notwithstanding the active lock-down condition. The lockset then unlocks and provides a visual indication that the lockset has been unlocked or that access has been granted. In this manner, the process allows selected users, such as administrators, emergency personnel, or other privileged users, to obtain access during a lock-down condition while denying access to users who would otherwise be authorized only during normal operation.

The flowchart also illustrates a central command path for initiating a lock-down from inside the secured area. An inside user presents credentials. The inside user then enters or requests a lock-down activation command. The system checks the inside user credentials and determines whether the inside user is authorized to initiate lock-down. If the inside user is authorized, the system sends one or more lock control commands to the selected locksets, including the first lockset, the second lockset, and any additional locksets through the Nth lockset. The lock control commands may cause the selected locksets to lock, remain locked, or otherwise enter a lock-down state.

If the inside user is not authorized to initiate the lock-down command, the system provides a visual indication of access denial. In that case, the system does not activate lock-down for the selected locksets unless another authorized command or condition is present.

In some embodiments, the central controller maintains a mapping between user credentials and lockset permissions. The mapping may identify which users can lock or unlock specific locksets, which users can initiate a lock-down, which users can override a lock-down, and which users can operate only selected doors or zones. The permissions may be stored locally at the central controller, distributed among the locksets, stored in a server, or synchronized between multiple control devices.

The system may further maintain a lockset group configuration. For example, a user command may apply to a single lockset, to a group of interior locksets, to all locksets in a wing or floor, or to all locksets in a facility. When a central command is received, the controller may determine which locksets are included in the command and send commands only to the included locksets. Locksets not included in the command may remain in their current state.

The process may also include feedback from the locksets to the central controller. A lockset may report whether it successfully locked or unlocked, whether a door is open or closed, whether a mechanical fault occurred, whether a battery condition exists, whether communication was successful, or whether tampering was detected. The central controller may use such feedback to update a visual display, generate an alarm, create an audit record, or retry a command.

The visual indications shown in FIG. 16 may represent different states, including access granted, access denied, lockset unlocked, lock-down active, command accepted, command rejected, or override accepted. The visual indications may be accompanied by audible, electronic, haptic, or network-based notifications. For example, an access denial may be displayed to a user and simultaneously recorded in an event log.

The illustrated process provides a coordinated access-control arrangement in which central credentials, outside credentials, inside credentials, lock/unlock commands, lock-down commands, and lock-down override permissions are evaluated in a structured manner. By distinguishing between normal entry authorization, lock-down activation authority, and lock-down override authority, the system can provide ordinary controlled access during normal conditions while maintaining heightened security during lock-down conditions. At the same time, the system permits authorized override users to unlock selected locksets during lock-down when appropriate.

Accordingly, FIG. 16 depicts a security-control method in which a central controller validates user credentials, receives lock or unlock commands, determines whether one or more locksets are included in the command, controls a plurality of locksets, evaluates outside entry requests, denies access when authorization is lacking, enforces lock-down conditions, and selectively permits override of lock-down by users having sufficient authority. The process thereby enables centralized and credential-based control of multiple locksets while supporting emergency or administrative lock-down functionality.

This modular and intelligent architecture enables flexible and robust security configurations, balancing centralized oversight with localized response capabilities.

### Examples

Example 1: A school building is equipped with the described wireless locksets on each classroom door. In the event of a security threat, the central controller issues a lockdown command to all locksets. Each lockset transitions into lockdown mode, indicated by a flashing red LED and a rotated indicator plate displaying “LOCKED.” Teachers inside classrooms can locally deactivate lockdown if permitted, using their credentials. Security personnel can override lockdown from outside using a master credential.

Example 2: A commercial office uses the system in Cardnet mode, where access rights are stored on employee badges. Even if the central controller is offline, authorized employees can access rooms, and local lockdown can be activated or deactivated as needed.

While the invention has been described in connection with specific embodiments thereof, it is to be understood that this is by way of illustration and not of limitation, and the scope of the appended claims should be construed as broadly as the prior art will permit.

What is claimed is:

1. A security control system for a plurality of enclosed areas secured by multiple doors having wireless lock mechanisms, each wireless lock mechanism comprising:
an external credential reader for normal access control to open the door from outside;
a central lockdown mode for receiving a lockdown command from a central controller to lock the door to prevent ingress or egress from the enclosed area;
a visual indicator for indicating when the lockset is in lockdown mode; and
an internal credential reader for allowing an authorized person to activate or deactivate the lockdown mode from inside the enclosed area.

2. The system of claim 1, wherein said lock mechanism can be toggled between lockdown mode and unlocked condition based on input from the central controller or the internal credential reader.

3. The system of claim 1, wherein the visual indicator comprises an LED display viewable through a 180° viewing angle in day and night conditions.

4. The system of claim 1, wherein the visual indicator comprises a turning display and flashing light to indicate lockdown mode activation and deactivation.

5. The system of claim 1, wherein the wireless lock mechanism comprises a wireless communication module for receiving centralized lockdown commands.

6. The system of claim 1, wherein the lockdown mode is activated by presenting a credential to the internal credential reader and deactivated by presenting the same credential again.

7. The system of claim 1, wherein the lockdown mode is activated by a lockdown command from the central controller and deactivated by presenting a credential to the internal credential reader.

8. The system of claim 1, further comprising an external override mode for allowing an authorized person to override the lockdown mode by presenting a master credential to the external credential reader.

9. The system of claim 1, wherein the external and internal credential readers communicate with transponder cards having access information stored on the cards.

10. The system of claim 9, wherein information from the transponder cards is compared with data stored in the lock mechanism to determine access.

11. The system of claim 9, wherein information from the transponder cards is compared with data stored at the central controller to determine access.

12. The system of claim 1, wherein said wireless lock mechanism comprises a lockset with a battery and a battery cover with a tamper detection feature.

13. The system of claim 1, further comprising an acoustic alert indicator for indicating when the lockset is in lockdown mode.

14. The system of claim 1, further comprising a door position sensor for determining whether the door is open or closed, and wherein information from said door position sensor is communicated to the central controller.

15. A wireless security control system for managing access to a plurality of enclosed areas, each area secured by a door equipped with a wireless lockset, the system comprising:
(a) a central controller configured to transmit lockdown commands to selected wireless locksets;
(b) a plurality of wireless locksets, each comprising:
an external credential reader configured to receive and process access credentials presented by users outside the door;
an internal credential reader configured to allow a user inside the enclosed area to activate or deactivate a lockdown mode by presenting a valid credential;
a wireless communication module configured to receive commands from the central controller and transmit door status information;
a visual status indicator, driven by an internal actuator, configured to display a "LOCKED" or "UNLOCKED" status with an LED backlight and a viewing angle of at least 180 degrees; and
an access logic processor configured to execute a lockdown override function in response to a master credential presented to the external credential reader; and
(c) at least one door position sensor associated with each wireless lockset and configured to detect and transmit door open or closed status to the central controller.

16. A method of managing secured access and lockdown functionality across a plurality of enclosed areas using a wireless security control system, comprising the steps of:
transmitting a centralized lockdown command from a central controller to one or more wireless locksets mounted on doors to the enclosed areas;
receiving the lockdown command at each wireless lockset and transitioning the lockset into a lockdown state wherein ingress and egress are prevented;
allowing an authorized person located inside an enclosed area to activate or deactivate the lockdown state locally by presenting a valid credential to an internal credential reader;
presenting a master credential at an external credential reader to override the lockdown state and permit access through the door;
updating a visual indicator on the lockset to display a locked or unlocked condition with a rotating display plate and backlit LED visible across at least 180 degrees; and
detecting and reporting door open/closed status to the central controller using a door position sensor associated with the wireless lockset.

17. A method of controlling a plurality of locksets, the method being performed by a controller and comprising:
receiving a lock-down mode command associated with a credential of a user, the lock-down mode command comprising at least one of a command to activate a lock-down mode or a command to deactivate the lock-down mode;
determining whether the user is authorized to change a state of the lock-down mode;
in response to determining that the user is authorized to activate the lock-down mode, activating the lock-down mode for one or more locksets of the plurality of locksets;
in response to determining that the user is authorized to deactivate the lock-down mode, deactivating the lock-down mode for the one or more locksets;
receiving an external credential associated with an external user requesting access to an enclosed area through an access point controlled by a first lockset of the plurality of locksets;
determining whether the external credential is authorized for normal access through the access point;
determining whether the lock-down mode is active for the first lockset;
in response to determining that the lock-down mode is not active and that the external credential is authorized for normal access, causing the first lockset to unlock;
in response to determining that the lock-down mode is active, determining whether the external credential is associated with lock-down override authority; and
in response to determining that the external credential is associated with the lock-down override authority, causing the first lockset to unlock notwithstanding the lock-down mode.

18. The method of claim 17, wherein receiving the lock-down mode command comprises receiving the lock-down mode command from an internal credential reader disposed inside the enclosed area.

19. The method of claim 17, further comprising causing an audio indicator, a visual indicator, or both to indicate that the lock-down mode is active.
